(19) United States
(12) Patent Application Publication
(10) Pub. No.: US 2004/0083296 A1
(43) Pub. Date: Apr. 29, 2004

(54) Apparatus and method for controlling user access

(76) Inventor: Max E. Metral, Boston, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/281,293

(22) Filed: Oct. 25, 2002

(51) Int. Cl. G06F 15/16; G06F 15/173

(52) U.S. Cl. 709/229; 709/225

(57) ABSTRACT

The present invention provides an apparatus and a method for controlling user access in a dial-up network by enforcing use of software to access a service provider. The method includes the steps of: receiving a user access request that contains authentication credentials; interpreting the authentication credentials to determine the presence of a characteristic; receiving a request from the user to access a first network address; and directing the user to a second network address based on detection of the characteristic. In some embodiments, the user provides authentication credentials containing a characteristic. Encryption or hashing techniques may be used to “tag” the user if the user is utilizing network-preferred software, thus creating the presence of the characteristic. The present invention provides a way to ensure users are using the network-preferred software so that the service provider can effect additional management controls over users.

### FIELD OF THE INVENTION

The present invention relates to an apparatus and a method for controlling user access to network resources and, in particular, for enforcing use of software to access a service provider.

### BACKGROUND OF THE INVENTION

In traditional systems for controlling user network access, user access is largely based on authentication of the user; that is, current user access systems are capable of verifying that a particular user has permission to access a requested network. Many network access systems use the Internet Protocol known as RADIUS (Remote Authentication Dial In User System) to provide users with access to dial-up networks. Network service providers that host large numbers of users, such as Internet Service Providers (ISPs), typically have limited management control over user network access.

One problem that limited management of user network access raises for these providers is balancing sufficient user access capacity with the cost to run an efficient network access system. For example, each user in a dial-up network system typically accesses the network via a modem, and each modem accommodates only a single user. As long as a user is connected via a particular modem, no other user can access that modem. When a user ties up a modem by not actively accessing the network, or if the user is merely “parked” to keep the modem line open indefinitely solely for their own use, costly system inefficiencies result from the inability of the service provider to utilize that particular modem for other users. If the service provider has no ability to exercise control over the parameters of the user's connection (such as timeout periods) once the user receives network access, the service provider must supply additional modems to ensure that all its users can conveniently access the network. The service provider would therefore be required to incur the additional expense because they have no other way to control the amount of inactive time a user can maintain a modem connection once access is granted.

Another cost-related problem encountered by service providers hosting large numbers of users is the large expense required in tracking and ensuring timely payment for user network access. Current network access systems can simply deny network access to delinquent users. However, in these systems it is more difficult, and often impossible, to facilitate prompt bill payment through the network itself. Without a way to electronically “tag” a user and exercise some level of control in directing them toward resolving billing deficiencies over the network, service providers are left with more traditional methods of tracking and following up on delinquent user invoices or denying users network access. Other difficulties faced by these service providers include controlling and managing the large array of user concerns and requirements with a limited amount of information and resources. Each customer service issue is often not complex or time consuming, but the costs associated with meeting the enormous volume of user demands in a timely manner can mount quickly.

In the current network access systems, the persistent dilemma is how to provide a higher quality, more streamlined, and cost efficient network access service by managing user network access.

### SUMMARY OF THE INVENTION

The present invention provides an apparatus and a method for controlling user access in a dial-up network by enforcing use of software to access a service provider. In one embodiment, the user provides authentication credentials that contain the presence of a characteristic. This method of controlling user access uses an encryption or hashing technique to “tag” the user if the user is utilizing network-preferred software, thus creating the presence of the characteristic. More specifically, the apparatus and method create a “reliable characteristic,” thereby warranting that the characteristic is not a forge. The present invention provides a way to ensure users utilize the network-preferred software so that the service provider can effect additional management controls over the users.

In one aspect of the present invention, the method for controlling user access includes: receiving a user's authentication credentials; interpreting the credentials to determine the presence of a characteristic; receiving a request from the user to access a first network address; and directing the user to a second network address based on detection of the characteristic. In one embodiment, the user access request is provided as a user name, a user password or both. The authentication credentials may be encrypted, or hashed, or any other industry standard encryption algorithms or integrity check techniques may be employed. In some embodiments, the Remote Authentication Dial In User Service (RADIUS) is used to receive user requests. In other embodiments, a further step of identifying a Domain Name System (DNS) access table for use in responding to requests received from the user based on interpretation of the user's authentication credentials may be added. In still other embodiments the user is directed to a second network address that displays a request for payment. In yet other embodiments, the user may be directed to a second network address that displays a notice to install new or upgraded software components.

In another aspect, the present invention relates to an apparatus for controlling user access in a dial-up network that includes: a first receiver for receiving user access requests containing authentication credentials and a hash of the authentication credentials; an interpreter for determining if the authentication credentials contain a characteristic; a second receiver for receiving user access requests for accessing a first network address; and a transfer module for directing users to a second network address based on detection of a characteristic. In some embodiments, the first and second receivers combine into a single receiver. The interpreter can include a decryption engine, a hash engine with a comparator or both.

In yet another aspect, the present invention relates to a means for controlling user access which includes: a first receiving means for receiving user access requests containing authentication credentials from a user; a means for determining if the authentication credentials contain a characteristic; a second receiving means for receiving user access requests for accessing a first network address; and a means for directing users to a second network address based on detection of the characteristic.

In still another aspect, the present invention relates to an article of manufacture that utilizes several computer readable programmable means. This article of manufacture includes: computer readable programmable means for receiving user access requests containing authentication credentials from a user; computer readable programmable means for determining if the authentication credentials contain a characteristic; computer readable programmable means for receiving user access requests for accessing a first network address; and computer readable programmable means for directing users to a second network address based on detection of the characteristic.

### BRIEF DESCRIPTION OF THE DRAWINGS

The invention is pointed out with particularity in the appended claims. The advantages of the invention described above, as well as further advantages of the invention, may be better understood by reference to the following description taken in conjunction with the accompanying drawings, in which:

FIG. 1A is a data flow diagram depicting traditional interaction between a client and server during a user request for access to a dial-up network;

FIG. 1B is a schematic diagram depicting an authentication package having the data format specified by the RADIUS protocol;

FIG. 1C is a schematic diagram depicting the RADIUS log in Internet Protocol address attribute format;

FIG. 2A is a data flow diagram depicting an embodiment of the present invention showing a method of interaction among a user desktop client, a client on an ISP modem and a server during a user request for access to a dial-up network;

FIG. 2B is a flow diagram depicting an embodiment of a method for controlling user access to a network;

FIG. 3 is a schematic diagram depicting data flow through an apparatus for controlling user access in a dial-up network;

FIG. 4A is a block diagram depicting an embodiment of an apparatus for controlling user access in a dial-up network; and

FIG. 4B is a block diagram depicting an embodiment of the present invention showing an alternative apparatus for controlling user access in a dial-up network.

### DETAILED DESCRIPTION OF THE INVENTION

Although various protocols for establishing dial-up network access have existed, the Internet Engineering Task Force (IETF) has promulgated a standard for establishing dial-up network access that is now generally used. That standard, RFC 2865, may be located at www.ietf.org/rfc.html, and is titled “Remote Authentication Dial In User System” (RADIUS).

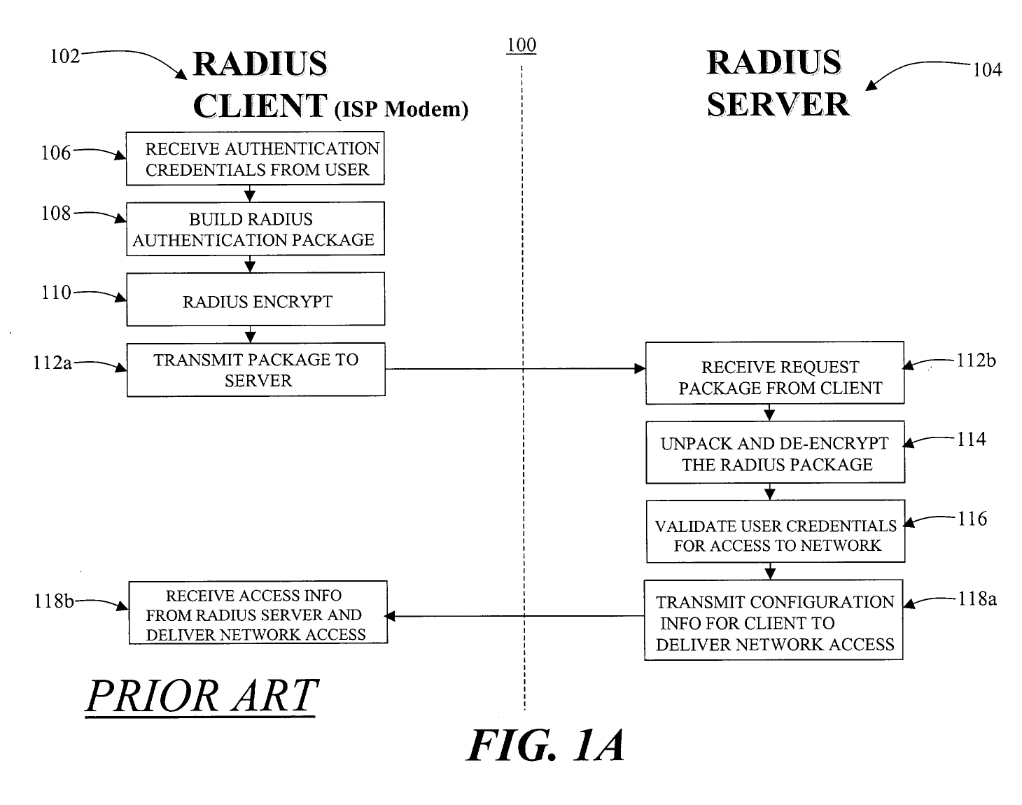

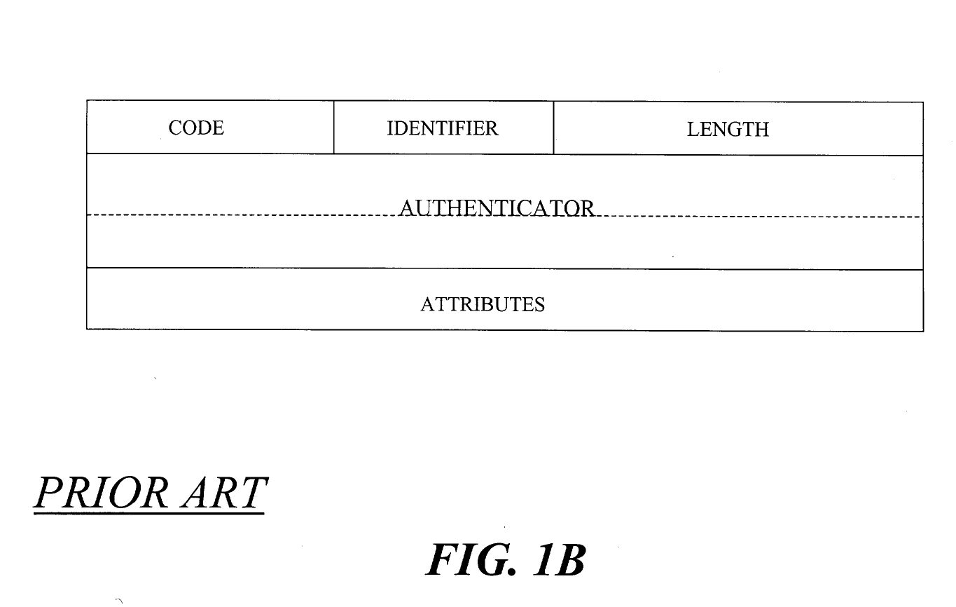

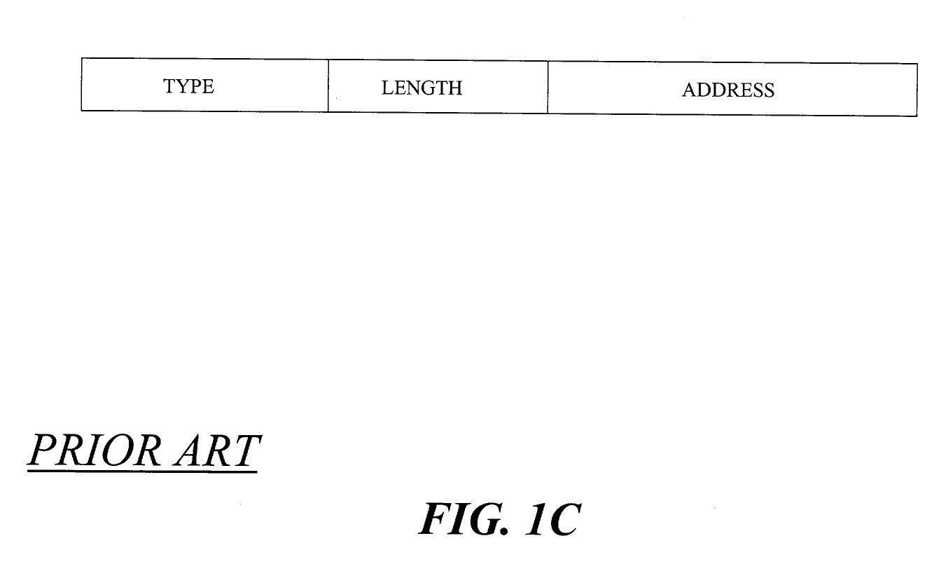

FIG. 1A depicts the data flow between a client 102 and a server 104 when establishing dial-up network access using the RADIUS protocol 100. First, the client 102 receives authentication credentials from a user (Step 106). Then the client 102 builds a RADIUS authentication package (Step 108). The authentication package is encrypted by RADIUS (Step 110), and transmitted (Step 112a) to the server 104. The server 104 receives the request package from the RADIUS client (Step 112b), at which point the RADIUS authentication package is unpacked and decrypted (Step 114). Once unpacked and decrypted, the RADIUS package extracts the authentication credentials and validates the credentials for establishing user access to the network (Step 116). If user access to the network is permitted, the configuration information allowing the RADIUS client 102 to deliver network access is transmitted (Step 118a) to the RADIUS client 102 from the server 104. After the client 102 receives the configuration information from the server 104, access to the network is provided to the user (Step 118b).

Referring in detail to FIG. 1A, the RADIUS protocol 100 is initiated when a RADIUS client 102 requests access to a dial-up network on behalf of a user. The RADIUS client 102 is a Network Access Server (NAS) that liaisons between the user and the RADIUS server 104. A user provides authentication credentials to the RADIUS client 102 to request network access. Upon receiving authentication credentials from the user (Step 106), the RADIUS client 102 arranges the credentials in a format suitable to the RADIUS protocol 100. The credentials include the user's name and/or password. The user password is hidden or encrypted using a shared key encryption technique.

The RADIUS client 102 may use the user authentication credentials to assemble a RADIUS authentication package (Step 108), similar to that shown in FIG. 1B. FIG. 1B is a schematic diagram depicting an authentication package having the data format specified by the RADIUS protocol. The RADIUS authentication package also includes: the code type of the authentication package; the client's own identification and the identification of the specific dial-up access port requested by the user; the length of the authentication package; the authenticator, which includes the password hiding algorithm and the respective share of the shared key encryption; and any other attributes desired for the network service requested.

FIG. 1C is a schematic diagram depicting a server log-in Internet Protocol (IP) address attribute format. This is an example of an attribute that can be used in the data format of FIG. 1B. The attribute of this particular example provides the information necessary for determining which network the user accesses.

Referring back to FIG. 1A, once the authentication package is encrypted (Step 110), the package is transmitted to a RADIUS server 104 over the dial-up system network (Step 112a). If all information in the package is correct and verifiable, the RADIUS server 104 receives the authentication package from the RADIUS client 102 and responds to the RADIUS client 102 that the package is validated and received (Step 112b). The RADIUS client 102 can repeat attempts to connect if there is an unsuccessful response to the first attempt.

Upon receipt of the package, the RADIUS server 104 unpacks the attributes of the authentication package (Step 114). The RADIUS server 104 first checks the encryption. If decryption is unsuccessful, then the authentication package is denied. If decryption succeeds, and as long as the client 102 is authorized by RADIUS, the server 104 checks the user name against a database of authorized users (Step 116). The user password is also similarly verified. The RADIUS server 104 also reviews the identification of the dial-up access port requested by the user to ensure that the port is accessible by that user. Once the user is authenticated, the RADIUS server 104 transmits configuration information (Step 118a) to the RADIUS client 102 so that the RADIUS client 102 can provide network access to the user (Step 1118b).

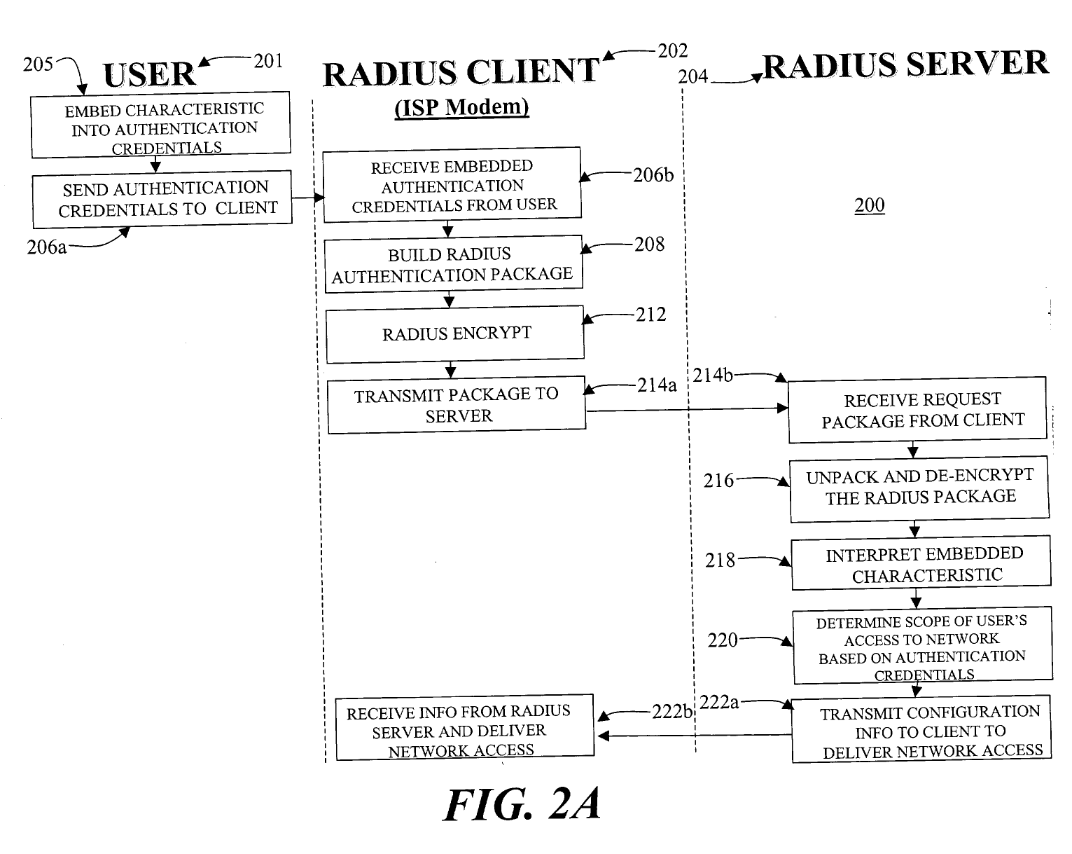

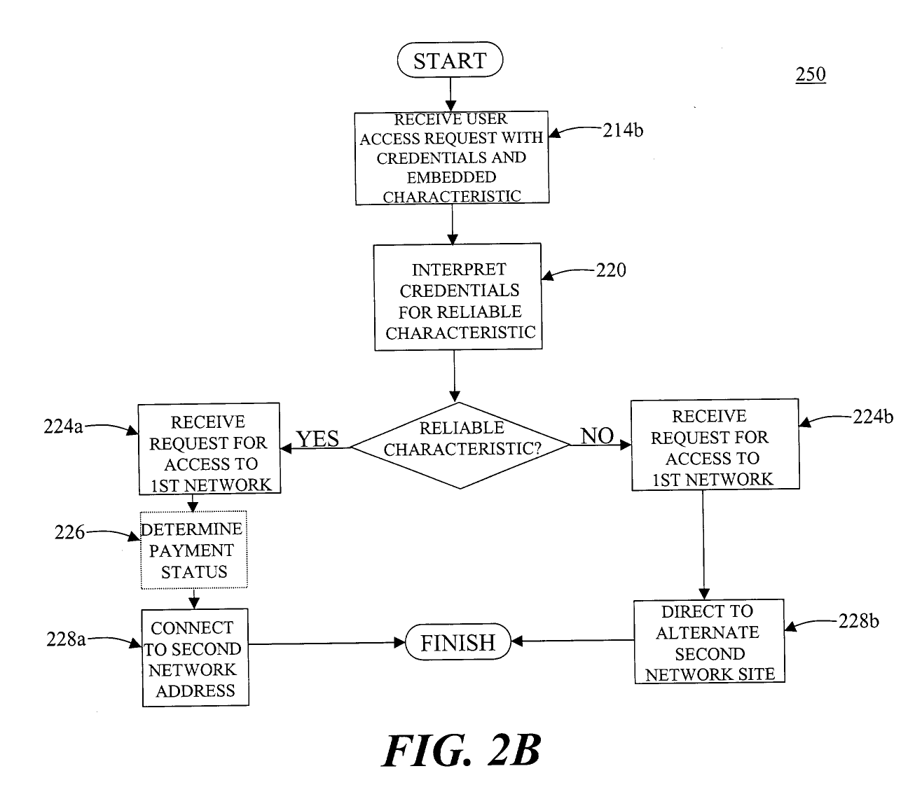

Referring now to FIG. 2A in brief overview, a data flow diagram depicting an embodiment of the present invention showing a method of interaction among a user desktop client 201, a client on an ISP modem 202, and a server 204 during a user request for access to a dial-up network 200 is shown. A user inputs authentication credentials at the user's desktop client 201. The authentication credentials are subsequently embedded with a characteristic (Step 205). The embedding process involves an encryption or tagging on the credentials indicating that network-preferred software is being used. The authentication credentials proceed to the client 202 (Step 206a). The client 202 receives the embedded authentication credentials (Step 206b) from the user desktop 201, and assembles a RADIUS authentication package (Step 208). A RADIUS or RADIUS-type encryption is then performed on the package (Step 212), before the package is transmitted (Step 214a) to the server 204. The server 204 receives the request package (Step 214b) from the client 202, and unpacks and decrypts the RADIUS information from the package (Step 216). Then the encryption or tag from the client 202 is matched to ensure the network-preferred software is being used for access (Step 218). Based on the authentication information and the profile of the network-preferred software, the scope of the user's access to the network is determined (Step 220). That information is included when the server 204 transmits configuration information to the client 202 for delivering network access to the user (Step 222a). The client 202 receives the information from the server 204 and, pursuant to the instructions provided, delivers network access (Step 222b) to the user.

Referring again to FIG. 2A, but now in greater detail, authentication credentials may be provided to the network in a variety of ways and manifest themselves in various forms. In general, authentication credentials comprise at least one of the following to identify the user to the network: something that the user has; something that the user knows; or something that the user is. In one embodiment of the invention, something the user has comprises a key or a magnetic card which is used to access the network. In another embodiment, digital certificates can be used to authenticate user credentials when a user transacts business over a network. One type of digital certificate includes: the name of the user, an identification number, effective dates of the certificate, and a copy of the public key associated with the certificate holder. Often, digital certificates also include digital signatures to enhance the integrity of the credentials.

In another embodiment, something the user knows comprises a password. For example, the authentication credentials may include a user name, a user password or both a user name and a user password. Alternatively, the authentication credentials comprise a two-factor authentication using one-time passcodes. One embodiment of a one-time passcode is a token-based, two-factor authentication system, such as the RSA SecuriD line of tokens (manufactured by RSA Security, Inc. of Bedford, Mass.). Tokens such as these have passcodes that change every 60 seconds.

In yet another embodiment, something the user has comprises biometric authentication material. Biometric material used for authentication includes fingerprints, handprints, DNA, retinal eye scans, facial recognition, voice recognition, and other unique biometric identifiers.

A unique tagging is embedded into the authorization credentials (Step 205) at the user's desktop client 201. This “tag” is referred to herein as a characteristic. The main purpose for the characteristic is to inform the network that a user is using the network-preferred software to access the network. By embedding a characteristic in the authentication credentials, the network exercises and automates management control over the user by triggering use of the network-preferred software. More specifically, the present invention creates a “reliable characteristic,” thereby warranting that the characteristic is authentic and not a forge.

The characteristic may be encrypted in the form of a shared key encryption. Examples of shared key encryption techniques that may be used to create the characteristic include: message digest algorithms, such as MD-5 (manufactured by RSA Security, Inc.); block ciphers, such as RC5 and RC6 (both manufactured by RSA Security, Inc.); Rijndael (designated as the Advanced Encryptions Standard by NIST), or MARS (manufactured by International Business Machines of Armonk, N.Y.); symmetric stream ciphers, such as RC4 (manufactured by RSA Security Inc.); and out-of-band, or non-explicitly communicated, data which are encrypted and/or digested data. An example of out-of-band data includes placing a user's birthday in the data packet and, even without communicating the birthday to both the embedding/encrypting and interpreting/decrypting ends of the communication, the birthday is known by both ends.

Once the user's desktop client 201 embeds the authentication credentials with the reliable characteristic (Step 205), the authentication credentials are sent to the client 202 (Step 206a). The client 202 receives the authentication credentials (Step 206b) and proceeds to build a RADIUS authentication package (Step 208). The authentication credentials may be arranged in one or more forms (Step 208). In one embodiment of the invention, an Internet Protocol, such as RADIUS, generates the authentication credentials. Authentication credentials similar to that described above for FIGS. 1A through 1C, serve as the foundation for the RADIUS authentication package (Step 208). In another embodiment, a proprietary method suited to the network generates the authentication credentials.

In addition, the authentication package is encrypted by the RADIUS encryption process (Step 212) described above. In all, two encryption-type processes are performed on the package; one process provides the characteristic embedded by the user's software at the user desktop client 201, and another provides the encryption that RADIUS requires at the ISP modem of the RADIUS client 202.

The package leaves the client 202 and is transmitted to the server 204 over the network (Steps 214a,b). This user access method can be employed over many different types of networks. As a representative example of network communications between the client 202 and server 204 in general, the client 202 and server 204 can communicate with each other using a variety of connections including: standard telephone lines; LAN or WAN links (e.g., T1, T3, 56 kb, X.25); broad band connections (ISDN, Frame Relay, ATM); and wireless connections. Connections can be established using a variety of lower layer communication protocols (e.g., TCP/IP, IPX, SPX, NetBIOS, Ethernet, RS232, direct asynchronous connections). Higher layer protocols, such as the Independent Computing Architecture protocol (ICA) (manufactured by Citrix Systems, Inc. of Ft. Lauderdale, Fla.), or the Remote Display Protocol (RDP) (manufactured by Microsoft Corporation of Redmond Wash.), can be used to allow client 202 access to a server farm, such as access to applications residing on the server 204.

The unpacking and decrypting of the RADIUS package (Step 216) is the same as that described for FIG. 1A above.

Next, the authentication credentials are interpreted for the reliable characteristic (Step 218) by seeking a match to the encryption or hash that is in place if a characteristic is properly embedded at the user's desktop client 201. The presence and type of characteristic resulting from a type of decryption process used to determine the scope of the user's access to the network (Step 220), and the transmission of the data to effect network access to the user (Steps 222a.b) is discussed in further detail below.

Referring now to FIG. 2B in brief overview, a flow chart depicting an embodiment of a method for controlling user access to a network 250 is shown. FIG. 2B depicts a more detailed description of the embodiment of the present invention shown in Steps 218 through 222a,b of FIG. 2A. The server receives the user access request package from the client with the authentication credentials and embedded characteristic (Step 214b). Next, the authentication credentials are interpreted to determine the presence of a reliable characteristic (Step 220). The user then requests access to a first network address (Steps 224a, b). If a reliable characteristic is present in the authentication credentials, the user is directed to a second network address (Step 228a). In one embodiment of the invention, the payment status of the user (Step 226) is determined between the receipt of the request for access to the first network (Step 224a) and the connection of the user to the second network address (Step 228a). If there is no reliable characteristic present in the authentication credentials, the user is directed to an alternate second network site (Step 228b).

Referring to FIG. 2B in greater detail, the reliable characteristic interpreted from the authentication credentials (Step 220) is an identifying element that is unique to the user and recognizable by the network, and is described in detail above. The “Yes” following the “Reliable Characteristic?” box indicates there is a reliable characteristic present in the authentication credentials. The “No” following the “Reliable Characteristic?” box indicates the absence of a reliable characteristic in the authentication credentials.

Once the network recognizes that the service provider's software is being used, based on the presence of a reliable characteristic (i.e., the “Yes” path), the service provider receives the request from the user for access to a first network address (Step 224a) and then forwards the user to a second network address (Step 228a). The first network address requested by the user (Step 224a) can comprise any network address or access point, such as a web address. The user request can be received via an Internet Protocol, such as RADIUS.

The user request for the first network address (Step 224a) is sent to Domain Name System (DNS) tables. In the case involving communications over the Internet, the request is made in domain name format. The DNS system is comprised of a complex hierarchical structure which processes large numbers of network address requests from domain servers, while maintaining and tracking domain names and IP address changes on a regular basis. DNS tables translate the more user-friendly domain names into the correct numeric network or IP address. The system also performs the reverse process of translating numeric IP addresses to domain names.

DNS tables are integrated within the network over a system of servers and, in some embodiments of the present invention, are configured to direct users to the appropriate network locations based on the presence or type of a characteristic. DNS tables compile a database of network addresses suited to the needs of the network service provider. Some DNS tables are static in that they are compiled in advance with a set library of domain name addresses. Alternatively, some DNS tables are dynamic; that is, the network can alter the DNS table contents at-will based on parameters set forth in a characteristic, for example.

In some embodiments, the presence of a characteristic in the user's authentication credentials causes the user to access a DNS table that has payment status information for network users (Step 226). By determining the presence of the characteristic and confirming the user is authorized to use the network, the service provider is able to manage user billing issues directly after the user obtains network access. Whether or not the user's payment status is current, the user is directed to a second network address. In one embodiment, if the user's payment status is not current, the scope defined by the characteristic requires the user to access a second network address via a DNS table that displays a request for payment. In another embodiment, the user is denied access to the DNS servers and precluded from accessing a selected network address until a billing matter is resolved.

In another embodiment of the invention in which the user's payment account is current, as determined by the scope of the characteristic, the user is permitted to access a requested network address. In some embodiments of this invention, connection to the second network address (Step 228a) yields access to various tools, such as additional DNS access servers or tables, information to install new or upgraded software components, or for downloading network access phone numbers, such as Digital Subscriber Line (DSL) lists. Other network management tools can also be implemented to tailor the network management requirements to meet the level of control desired by the service provider.

Alternatively, requests for access to a first network that lack a characteristic are rejected from the network via an alternate second network site (Step 228b). Network traffic that lacks the characteristic is prohibited from network access other than the conduit between the service provider's restricted DNS servers and the service provider's web server. In one such embodiment, upon failure to detect a reliable characteristic, the service provider's server takes control over the DNS server and enforces use of the service provider's systems and protocols, thereby changing the user profile before sending the user request back to the modem for enforcement.

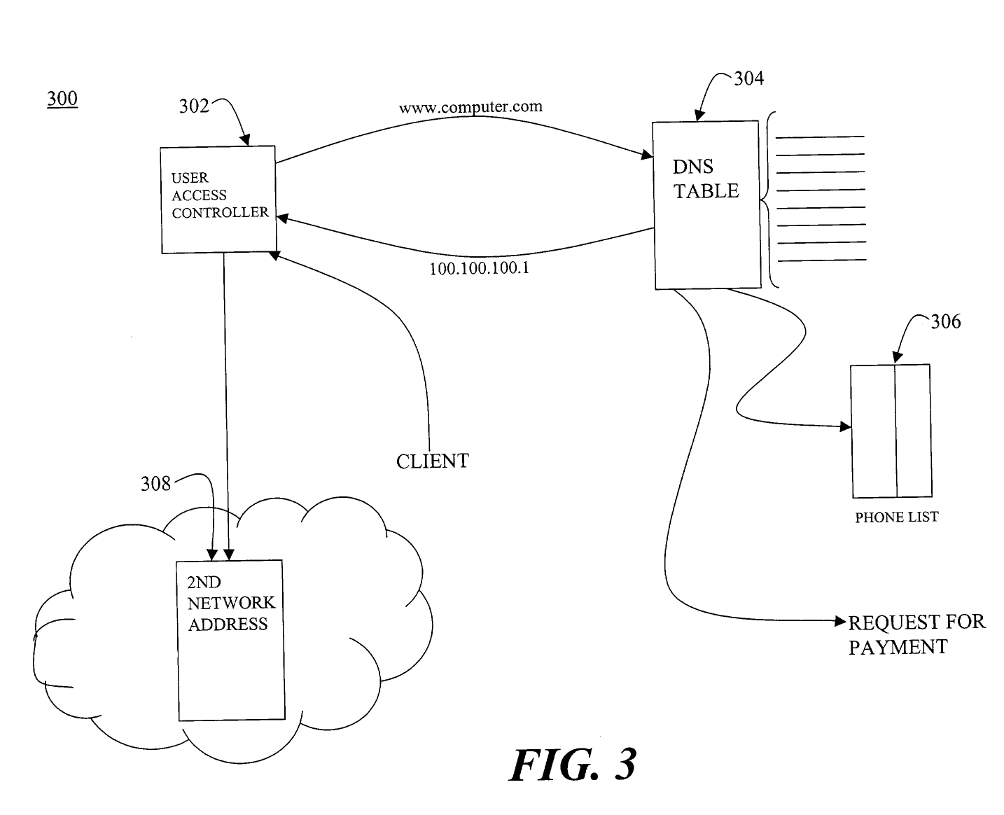

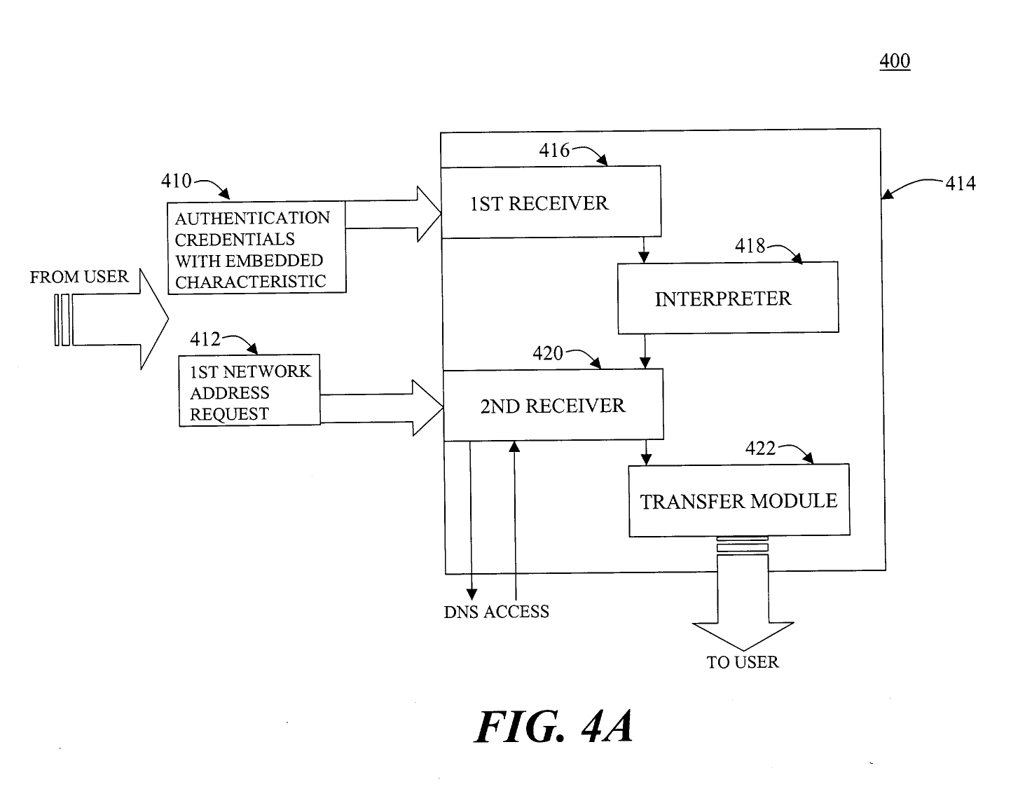

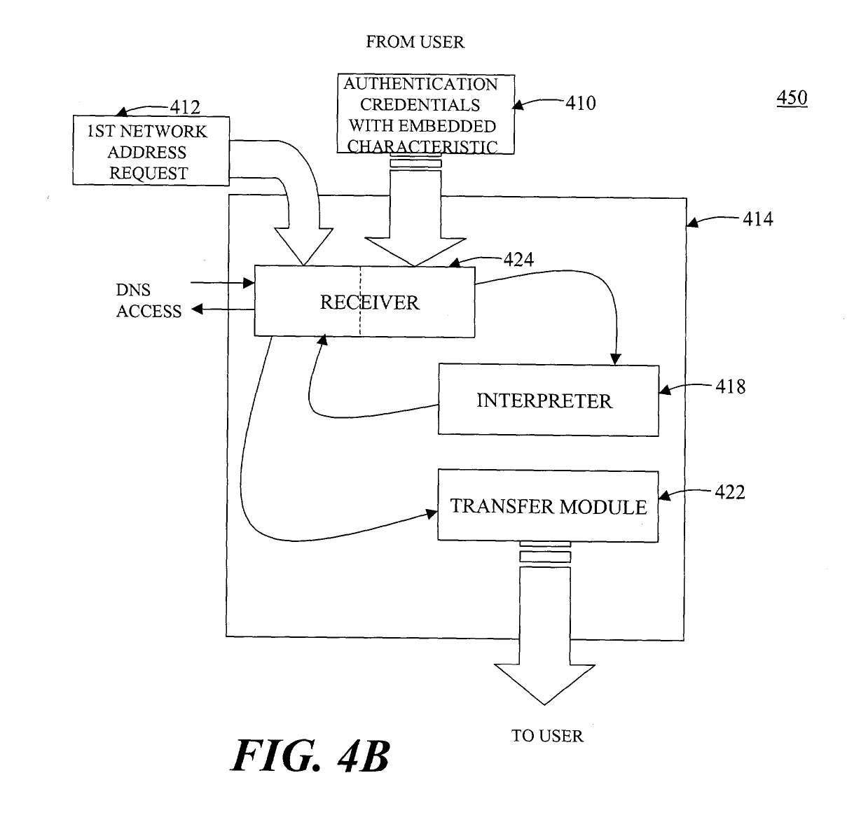

FIG. 3 is a schematic diagram depicting data flow through an apparatus for controlling user access in a dial-up network 300. A user, through a client, accesses a user access controller by providing authentication credentials. The user access controller 302 performs the functions described in greater detail for FIGS. 4A and 4B below. The user access controller 302 accesses the network DNS table 303, phone lists 306 and/or other displays, and receives and processes the first network user access request. The selected DNS tables 304 return the IP address, corresponding to a particular network location, back to the user access controller 302. The user is then sent to a second network address 308 based on the presence and scope of the characteristic found.

If there is a reliable characteristic, the user access controller 302 may exercise any one of several options. In one embodiment, the user access controller 302 accesses DNS tables 304 that provide an IP address that displays information to the user based on the characteristic and the network address requested. Such displays may include a request for payment or a notice to install or upgrade software components. In another embodiment, the user is directed to an IP address, via DNS tables, to download alternate network access phone numbers 306. In yet another embodiment, the user is directed to the user access controller 302, and the user is then directed to a second network address 308 via another DNS table.

Referring now to FIG. 4A in brief overview, a block diagram depicting an apparatus for controlling user access in a dial-up network is shown 400. The server's user access controller 414 receives authentication credentials 410, including a hash or encryption required to enable the characteristic, from the user via the client. The user access controller 414 is comprised of a first receiver 416, an interpreter 418, a second receiver 420, and a transfer module 422. The first receiver 416 receives the authentication credentials 410. The first receiver 416 sends the credentials 410 to the interpreter 418 for processing of the credentials 410 and the characteristic. The second receiver 420 then receives the interpreted authentication credentials 410 from the interpreter 418 and also receives a user request for access to a first network address. The second receiver 420 accesses at least one DNS table to process the first network address request 412. The instructions received and processed in the second receiver 420 are forwarded to the transfer module 422 to determine where the user is sent.

Referring again to FIG. 4A, but now in greater detail, the user access controller 414 processes the authentication credentials 410 and sends the user to the proper network address. The first receiver 416 serves as an access portal to the server. After the user's authentication credentials 410 are embedded with the characteristic and the RADIUS or RADIUS-type encryption and then transmitted to the server, the first receiver 416 accepts the package and prepares the package for the interpreter 418. The first receiver 416 may be provided as a software module in the form of a subsystem that “listens” on a defined port for transmitted authentication credentials 410. Alternatively, the first receiver 316 may be provided as hardware. In these embodiments, the first receiver may be a special purpose piece of hardware, such as an application-specific integrated circuit (ASIC), a field-programmable gate array (FPGA) or a program logic device (PLD). In others of these embodiments, the first receiver 316 is a receiver chip that handles receipt and transmission of data over the network. In these embodiments, the receiver chip may be associated with an ASIC, an FPGA or a PLD.

The interpreter 418 unpacks the package and decrypts the RADIUS portion of the package. The interpreter 418 then interprets the authentication credentials 410 to determine the presence of the characteristic. In one embodiment, the interpreter 418 includes a decryption engine. A decryption engine decrypts encrypted data. In one aspect, the decryption engine decrypts the RADFUS encryption, and in another aspect, the decryption engine decrypts the characteristic encryption. In yet another aspect, an encryption engine decrypts both the RADIUS encryption and the characteristic encryption.

In another embodiment, the interpreter 418 includes a hash engine and a comparator. The hash engine performs a hash function on the authentication credentials after the first receiver 416 receives the credentials. The comparator compares the result of the hash function performed on the authentication credentials 410 as received by the first receiver 416 with the hash function result performed on the authentication credentials 410 by the client. If those results match, then the credentials bear the characteristic. If there is not a match, then there is no presence of a characteristic. In yet another embodiment of the present invention, the interpreter includes both a decryption engine and a hash engine with a comparator. Similar to the first receiver 416 described above, the decryption engine, encryption engine, and hash engine with comparator may be provided as either software, such as a software module, or as hardware, such as an ASIC, an FPGA, or a PLD.

Once the presence of the characteristic is determined, the second receiver 420 receives the authentication credentials 410. The second receiver 420 may be provided as either hardware or software in a similar fashion to that described above for the first receiver 416. The second receiver 420 not only receives the authentication credentials 410, but also receives the first network address request 412 from the user. The presence of a characteristic in the authentication credentials 410 determines in large part the scope of the user's request for access to a first network 412. If there is no characteristic present, the user's request 412 is promptly transmitted to the transfer module 422. If there is a characteristic, then the second receiver 420 may exercise any one of several options. In one embodiment, the second receiver 420 may access DNS tables that direct the user to a display based on the characteristic and the requested network address. Such displays may include a request for payment or a notice to install or upgrade software components. In another embodiment, the user is directed to DNS tables that provide network addresses for downloading alternate network access phone numbers. In yet another embodiment, the user is directed to the transfer module 422.

The transfer module 422 is the egress point of the user access controller 414. The transfer module 422 receives the input from the second receiver 420 and processes the user to a second network address based on the presence and type of characteristic. In the absence of a reliable characteristic, access to the DNS table may be crippled to the user. Alternatively, the presence of a reliable characteristic may result in the determination by the transfer module 422 as to which DNS table the user has access. In both of those cases, the user accesses a static DNS table. However, some types of characteristics may prompt a modification to an existing DNS table, thereby engaging a dynamic DNS table. The transfer module 422 may be provided as a software module subsystem that “listens” on a defined port for input from the second receiver 420. Alternatively, the transfer module may be provided as hardware in the form of an ASIC, an FPGA, a PLD or as a chip that handles receipt and transmission of data over a network, or any combination of such elements.

Referring now to FIG. 4B, a block diagram depicting an embodiment of the present invention where an alternative apparatus for controlling user access in a dial-up network is shown 450. FIG. 4B is similar to FIG. 4A except that FIG. 4B depicts a user access controller 414 with a single receiver performing the functions of both the first and second receivers. A unitary receiver 424 receives the authentication credentials 410. The receiver 424 sends the credentials 410 to the interpreter 418 for processing of the credentials 410 and the characteristic. The receiver 424 then receives the interpreted authentication credentials 410 from the interpreter 418 and also receives a user request for access to a first network address 412. The receiver 424 accesses at least one DNS table to process the first network address request 412. The data received and processed in the receiver 424 are sent to the transfer module 422 to determine where the user has access and where the user is sent.

The user access controller 414 functions in a comparable manner to the process described for FIG. 4A above. Similarly, the receiver 424 functions substantially the same as discussed for the first receiver 416 and the second receiver 420 above. In one embodiment, the receiver 424 is partitioned such that the section of the receiver 424 which performs the functions of the first receiver 416 of FIG. 4A is physically separated from the section of the receiver 424 which performs the functions of the second receiver 420 of FIG. 4A. It may also be noted that any other means of receiving, interpreting or transferring data to facilitate user access control that is recognized by those skilled in the art may be used.

The present invention can be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, LISP, PERL, C, C++, PROLOG, or any byte code language such as JAVA. The software programs may be stored on or in one or more articles of manufacture as object code.

The various embodiments of the apparatus and method described herein for the exercise of management control over network users can be implemented in a number of contexts, in addition to those previously explained. For example, users may be confined to access only a subset of available DNS tables or network addresses. The subset may be determined based on pricing of service that limits the number and types of DNS tables or network addresses available to a given user. The subset may be determined by eliminating access to certain prohibited network addresses. In this context, the present invention may be employed for preventing or blocking children or employees from accessing particular network addresses.

### EXAMPLES

The following examples illustrate ways of using the invention.

By way of a first example, a user accesses the system via a telephone dial-up communications link to the World Wide Web. The system displays a welcome page, which prompts the user to enter authentication credentials to access the network. The user enters biometric data, such as a fingerprint, to authenticate access.

Once the user enters the authentication credentials, the user's desktop client embeds the authentication credentials with a reliable characteristic. The characteristic in this example is embedded using the message digest algorithm MD-5.

After the authentication credentials are embedded with the characteristic, the RADIUS client on the ISP modem receives the authentication data. The RADIUS client packages the authentication data into a RADIUS-formatted authentication package. The authentication package is then encrypted using a second MD-5 message digest algorithm before it is communicated over a network to the RADIUS server.

The RADIUS server receives the encrypted authentication package from the RADIUS client and unpacks and decrypts the RADIUS authentication package using a decryption engine. The decryption engine also uncovers the characteristic. The user's request for a first network address is received, and the scope of the characteristic does not permit the user access to the network address requested due to detection of out-of-band data which includes the user's birthday.

In this example, the user is prohibited from accessing network addresses deemed unsuitable for children under 18 years of age. Instead, the user is directed to an alternate static DNS table that points to a “Warning” page. The page contains an icon which the user can click on to allow the user to enter an alternate network address request. Alternatively, the user may be directed to a dynamic DNS table in which the prohibited network addresses are removed upon detection of the birthday data.

Upon entering the alternate network address, the scope of the user's characteristic is again evaluated. Now, the user is permitted to access the alternate requested network address and is directed to that address via another DNS table.

By way of a second example, a user provides a user name and a user password to the desktop client, which receives the user name and password. The user name and password is encrypted to attempt to create a characteristic using Rijndael Advanced Encryption Software, and the RADIUS client on the receiving modem performs an MD-5 encryption on the authentication package.

The package is transmitted over a network from the client to the RADIUS server where the first receiver receives the package. The first receiver is a software subsystem that transfers the authentication package to the interpreter, also a software subsystem. The package is unpacked and no reliable characteristic is present. The second receiver sends instructions to the transfer module (both comprised of software subsystems) that access to the network is accepted, but modified such that all subsequent network access is redirected to a message or service of the choosing of the ISP. The user is crippled from access to the network, and instead the user is sent via a DNS table of restricted scope to a “network access denied” display. The user's profile is subsequently changed and the user's original network address request is sent back to the modem for enforcement. The user returns to a restricted DNS table that maps to a single internet address prompting the user to download the required software to access the network.

Having described certain embodiments of the invention, it will now become apparent to one of skill in the art that other embodiments incorporating the concepts of the invention may be used. Although the described embodiments relate to the field of enforcing use of software to access a service provider, the principles of the invention can extend to other areas that involve controlling user access to computer network resources. Therefore, the invention should not be limited to certain embodiments, but rather should be limited only by the spirit and scope of the following claims.

What is claimed is:

1. A method for controlling user access in a dial-up network, the method comprising the steps of:
(a) receiving a user access request, the request comprising authentication credentials;
(b) interpreting the authentication credentials to determine the presence of a characteristic;
(c) receiving a request from the user to access a first network address; and
(d) directing the user to a second network address based on detection of the characteristic.

2. The method of claim 1 wherein step (a) comprises receiving a user access request comprising a user name and a password.

3. The method of claim 1 wherein step (a) comprises receiving a user access request comprising encrypted authentication credentials.

4. The method of claim 1 wherein step (b) comprises interpreting the authentication credentials to determine whether the authentication credentials are encrypted.

5. The method of claim 1 wherein step (c) comprises receiving a request from the user via the Remote Authentication Dial In User Service (RADIUS) protocol.

6. The method of claim 1 further comprising the step of identifying, responsive to the authentication credential interpretation, a Domain Name System (DNS) access table for use in responding to requests received from the user.

7. The method of claim 1 wherein step (d) comprises directing the user to a second network address that displays a request for payment.

8. The method of claim 1 wherein step (d) comprises directing the user to a second network address that displays a notice to install new or upgraded software components.

9. The method of claim 1 further comprising, responsive to the authentication credential interpretation, downloading network access phone numbers.

10. An apparatus for controlling user access in a dial-up network, the apparatus comprising:
a first receiver for receiving user access requests from a user, the requests comprising authentication credentials and a hash of the authentication credentials;
an interpreter for determining if the authentication credentials contain a characteristic;
a second receiver for receiving user access requests for accessing a first network address; and
a transfer module for directing users to a second network address based on detection of the characteristic.

11. The apparatus of claim 10 wherein a single receiver comprises both the first receiver and the second receiver.

12. The apparatus of claim 10 wherein the interpreter comprises a decryption engine.

13. The apparatus of claim 10 wherein the interpreter comprises a hash engine and a comparator.

14. A means for controlling user access in a dial-up network, the means for controlling user access comprising:
a first receiving means for receiving user access requests from a user, the requests comprising authentication credentials;
a means for determining if the authentication credentials contain a characteristic;
a second receiving means for receiving user access requests for accessing a first network address; and
a means for directing users to a second network address based on detection of the characteristic.

15. An article of manufacture having computer readable programmable means embodied thereon comprising:
computer readable programmable means for receiving user access requests from a user, the requests comprising authentication credentials;
computer readable programmable means for determining if the authentication credentials contain a characteristic;
computer readable programmable means for receiving user access requests for accessing a first network address; and
computer readable programmable means for directing users to a second network address based on detection of the characteristic.
